(19) United States
(12) Patent Application Publication
(10) Pub. No.: US 2001/0034625 A1
(43) Pub. Date: Oct. 25, 2001

(54) System and method for electronically estimating travel costs

(76) Inventor: Daniel S. Kwoh, La Canada, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/765,535

(22) Filed: Jan. 18, 2001

Related U.S. Application Data
(60) Provisional application No. 60/176,680, filed on Jan. 18, 2000.

(51) Int. Cl. G06F 17/60

(52) U.S. Cl. 705/6

(57) ABSTRACT

A system and method for calculating travel costs for a user where a user is prompted to enter desired travel product information. After desired travel product information is received from a user, the received information is used to search through a database of travel products to determine the cost of the desired travel products. The cost of the desired travel products is then reported to the user. The user is prompted to request alternative travel product information. If a user requests to receive alternative travel product information then a discount database is accessed to determine alternative travel products to offer to the user. The alternative travel products are then reported to the user.

### CROSS-REFERENCE TO RELATED APPLICATION

This application claims priority of U.S. Provisional Patent Application No. 60/176,680 filed on Jan. 18, 2000, the entire contents of which are hereby incorporated herein by reference.

### BACKGROUND OF THE INVENTION

With the advancement of the Internet, electronic travel agencies for searching and booking airline tickets have become common. With more and more hotels and car rental agencies joining the ranks of e-commerce, a complete travel product package can be determined and booked without physically speaking to a travel agent. Presently, the booking of travel products over the Internet requires a user to input their exact requirements in terms of time and date of travel, destinations, types of hotels at which the user wishes to stay, etc. After the user inputs their exact requirements, the system searches through one or more databases and comes up with available products that satisfy the user's exact requirements and prices for the available products. Although the system may satisfy the needs of a customer based on the input requirements, this is not equivalent to customer interaction with a live travel agent.

Usually, when a customer interacts with a live travel agent, customer needs are determined through an interactive set of questions and answers, and some of the requirements are actually indeterminate and vague, subject to modification. For example, the customer may leave either on Friday or Saturday, but may have a preference for one of the two days. Depending on the price difference between the two days, the customer might choose one day over the other due to the price difference. A live travel agent is able to search and provide optimized travel packages in a way that current Internet-based electronic travel agencies cannot.

There remains a need for an Internet-based electronic travel agency to provide a means of finding out prices of travel products similar to those requested by a customer, as well as the price variations of each, and to present various options to a customer for the customer to choose from.

### SUMMARY OF THE INVENTION

This invention, according to an embodiment, discloses a system and method by which a customer inputs desired travel product information. Once desired travel product information is received from a user the received information is used to search through a travel product database to determine the cost of the desired travel products. Once the cost of the desired travel products is obtained, the cost of each travel product is reported to the user. The user is also prompted to view alternative travel products. If a request to view alternative travel products is received, then a discount database is accessed in conjunction with travel products databases, and the initial user travel product request, to select alternative travel products. Alternative travel products are then selected and reported to the user.

In an embodiment, a user is prompted to select an airline departure date, a departure location, a destination location, and a seat class. The user is also prompted to enter a hotel location and a number of nights to reside at the hotel. Furthermore, a user is prompted to select a rental car location and a number of days a rental car will be rented. As an alternative to the user entering the number of nights to reside at the hotel and the number of days a rental car will be rented, the duration of time between the airplane departure date and the airplane return date may be used. Therefore, the number of days a rental car will be rented may be automatically changed when the flight information is changed. As an alternative to the user entering the hotel location and the rental car location the airplane destination city may be used. Therefore, the hotel location and the rental car location may be automatically changed when the flight information is changed.

In another embodiment of the present invention, a user may select cruise travel products in conjunction with airplane, hotel and car rental travel products. A user is prompted to enter cruise product request information including a cruise departure date, a cruise departure location, a cruise destination location, a cruise return date, and a cruise passenger class.

In an embodiment, when displaying travel products, the system displays estimated prices for each travel product based upon availability of products from different product providers. The travel product display also has an estimated total price for all of the requested travel products.

In an embodiment, the user is prompted to request alternative travel product information. In response to a request for additional travel product information, a discount database is accessed to determine alternative travel products to offer the user. The alternative travel products are found by altering at least one of the departure flight city, the departure flight date, the destination city, the return flight date, the number of nights of hotel rental, the type of hotel rented, the number of days of car rental, and the type of car rented to conform to the requirements of at least one discount found in the discount database. In an alternative embodiment, alternative travel product information is automatically found and displayed for a user.

In an additional embodiment of the present invention, once a user has selected a set of travel products which meets their needs, the user is prompted to purchase the selected travel products. If the user elects to purchase the selected travel products, then the user is prompted to enter personal information and payment information to initiate the purchase. Once the personal and payment information is obtained from a user, or from prior account information maintained for the user, the system contacts the travel product provider and reserves and purchases the selected travel products.

### BRIEF DESCRIPTION OF THE DRAWINGS

These and other features and advantages of the present invention will be better understood by reference to the following detailed description when considered in conjunction with the accompanying drawings wherein:

FIG. 1 is a block diagram showing the relationship of parts of a system for estimating travel costs in accordance with one embodiment of the present invention;

FIG. 2 is a block diagram of a system for estimating travel costs in accordance with an embodiment of the present invention;

FIG. 3 shows the contents of a database of airline flight prices according to an embodiment of the present invention;

FIG. 4 shows the contents of a database of airline flight discount criteria and statistics according to an embodiment of the present invention;

FIG. 5 shows the contents of a database of hotel information and prices according to an embodiment of the present invention;

FIG. 6 shows a database of hotel discounts according to an embodiment of the present invention;

FIG. 7 shows a database of car rental prices and information according to an embodiment of the present invention;

FIG. 8 shows a database of car rental discount information according to an embodiment of the present invention;

FIG. 9 shows a user interface for user entered information according to an embodiment of the present invention; and

FIG. 10 shows the results presented to a user according to an embodiment of the present invention.

### DETAILED DESCRIPTION OF THE INVENTION

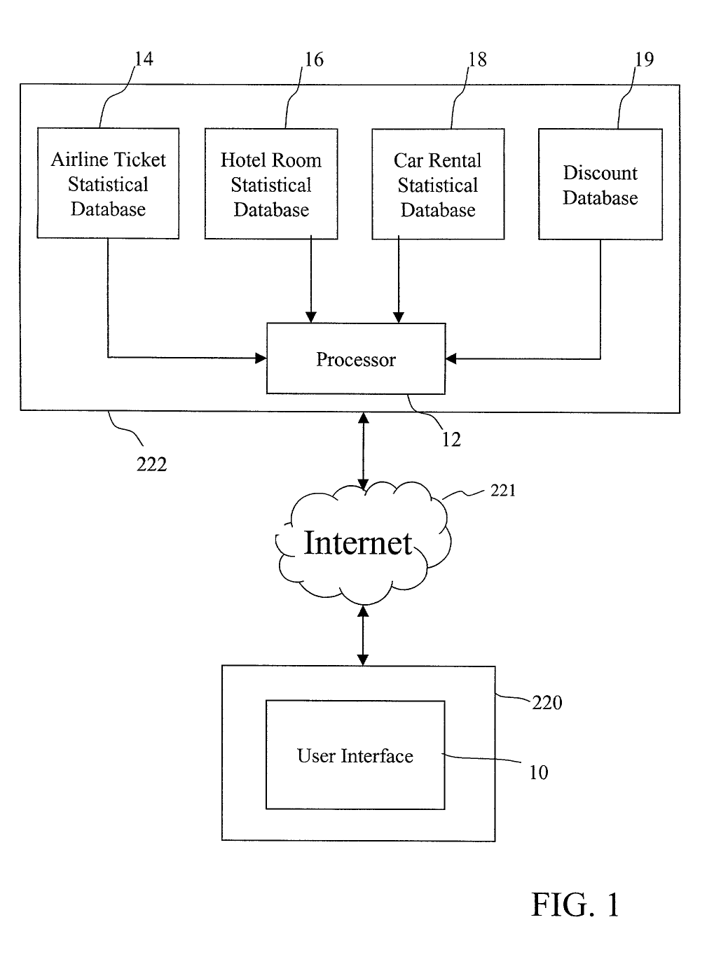

An overview of an embodiment of the present invention is shown in FIG. 1. The system functions between a user device 220 and a server 222 communicating through the Internet 221. The server communicates a user interface 10 to the user device. The user device is coupled to a processor 12 within the server. The processor is in turn linked to an airline ticket statistical database 14, a hotel room statistical database 16, a car rental statistical database 18, and a discount database 19. Once travel product attributes are entered into the user interface 10 by a user, the user interface communicates with the processor 12. The processor retrieves relevant airline ticket price information and schedule information from the airline ticket statistical database 14. The processor 12 also obtains price and attribute information about hotel rooms from the hotel room statistical database 16. Furthermore, the processor receives car rental price and attribute information from the car rental statistical database 18. The processor then receives information from one or more discount databases to find alternative travel products.

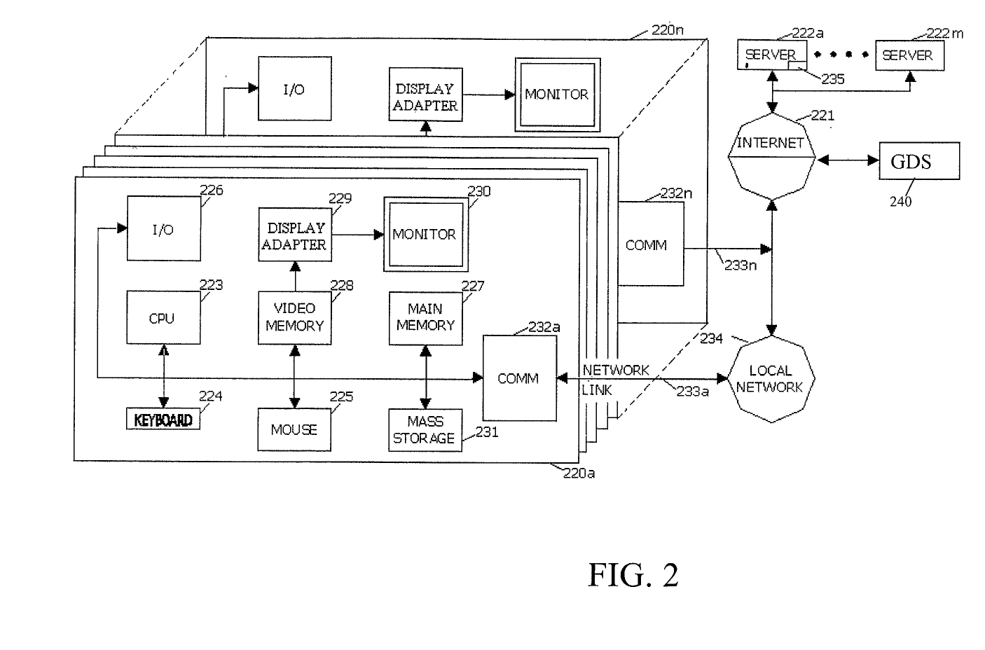

FIG. 2 shows a block diagram of a typical Internet client/server environment used by the users and servers in one embodiment of the present invention. User devices 220a-220n used by the users are connected to the Internet 221 through communication links 233a-233n. Optionally, a local network 234 may serve as the connection between some of the user devices 220a-220n, such as the user device 220a and the Internet 221. Servers 222a-222m are also connected to the Internet 221 through respective communication links. Servers 222a-222m include information and databases accessible by the user devices 220a-220n. In one embodiment of the present invention, databases for storing travel product information reside on at least one of the servers 222a-222m and are accessible by users using one or more of the user devices 220a-220n to obtain travel product information.

In an alternative embodiment of the present invention, the travel product databases are stored on a Global Distribution System 240. Travel product information, including current travel prices and availability, is gathered from travel product providers and stored on the Global Distribution System 240. The Global Distribution System 240 is accessible by at least one of the servers 222a-222m through the Internet.

In yet another alternative embodiment, the travel product databases are stored on computers of the individual travel product providers. Each of the travel product databases stored on computers of the individual travel product providers contains travel product information, including current prices and availability. The databases stored on computers of the individual travel service providers are accessible by at least one of the servers 222a-222m through the Internet.

In one embodiment of the present invention, each of the user devices 220a-220n typically includes a central processing unit (CPU) 223 for processing and managing data; and a keyboard 224 and a mouse 225 for inputting data. A main memory 227 such as a Random Access Memory (RAM), a video memory 228 for storing image data, and a mass storage device 231 such as a hard disk for storing data and programs are also included in a typical user device. Video data from the video memory 228 is displayed on a Display screen 230 by a display adapter 229 under the control of the CPU 223. A communication device 232, such as a modem, provides access to the Internet 221. Optionally, one or more of user devices 220a-220n may be connected to a local network 234. An Input/Output (I/O) device 226 reads data from various data sources and outputs data to various data destinations.

Servers (hosts) 222a-222m are also computers and typically have architecture similar to the architecture of user devices 220a-220n. Generally, servers differ from the user devices in that servers can handle multiple telecommunications connections at one time. Usually, servers have more storage and memory capabilities, and higher speed processors. Some server (host) systems may actually be several computers linked together, with each handling incoming web page requests. In one embodiment, each server 222a-222m has a storage medium 236a-236m, such as a hard disk, a CD drive, or a DVD for loading computer software.

When software such as the software responsible for executing the processes in FIGS. 1 and 3 to 10 is loaded on the server 222a, an off-the-shelf web management software or load balancing software may distribute the different modules of the software to different servers 222a-222m. A server may utilize an operating system such as DOS, Microsoft Windows, or Linux. The server may use off the shelf, or open source software to generate and serve web pages. In an embodiment, the server uses Apache server software to generate and serve web pages. The page generating software generates web pages that have, for example, hypertext markup language (HTML) and Javascript components. Additionally, the server may be protected from unauthorized access by the use of a firewall, such as one produced by Checkpoint.

Therefore, in one embodiment, the computer program responsible for executing the present invention resides on one or more servers. Databases to carry out the processes of FIGS. 1 and 3 to 10 may be created, maintained and edited in many different types of database software including Access, FoxPro, and Oracle. In one embodiment of the present invention the database software is made by Oracle.

An exemplary web site location 235 is shown on server 222a in FIG. 2. The web site 235 is the user interface for accessing the database described below. The web site 235 has a unique address that is used by the users to access server 222a (in this example) and the web site location on the server 222a. The computer software for executing the processes of the present invention may also reside on the web site 235.

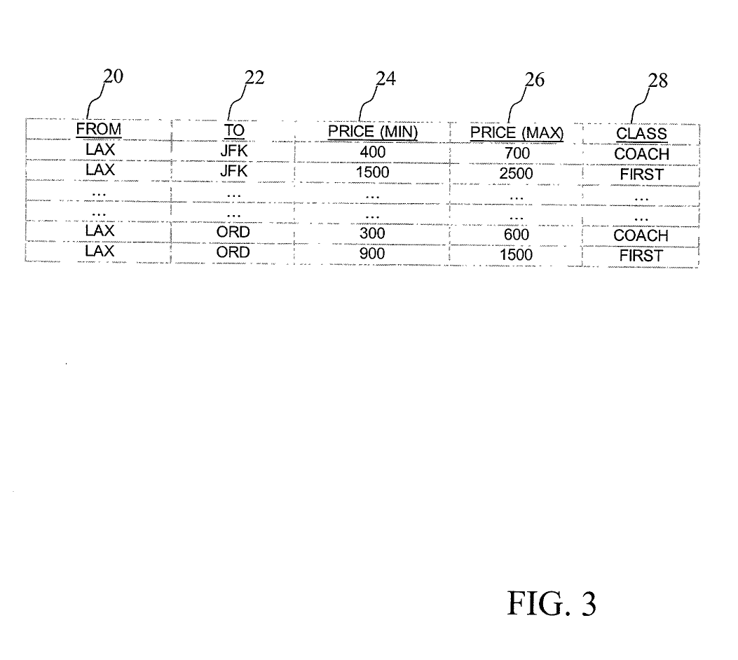

FIG. 3 shows a representative portion of the airline ticket statistical database 14. As shown in FIG. 3, an airline statistical database, according to an embodiment of the invention, contains several different fields. Those fields include the departure location 20, the arrival location 22, the minimum price 24, the maximum price 26, and the seat class of the entry 28.

Additionally, the airline ticket statistical database may contain fields for specific dates and days. In an embodiment, the minimum and maximum prices reflect a range that has been obtained by viewing the different prices offered by each airline travel provider, for a particular departure location, arrival location and seat class for a specific day and time period. In an additional embodiment, the airline ticket statistical database may contain information about the meals, movies, and consumer ratings for each flight, which may be communicated to a user, to help them select a flight.

In yet another additional embodiment, the processor accesses the databases of each airline travel provider at the time the user enters their request for travel products. The processor searches the databases of the airline travel providers using any relevant information provided by the user, such as the date of departure, city of departure, destination city, and return date. The processor then computes a range of prices from a minimum price to a maximum price, based on the prices found for flights that satisfy the user's travel product request. Searching travel product provider databases at the time of the user's travel product request, based on the parameters of the user's request, may be done for additional travel products, such as those discussed below.

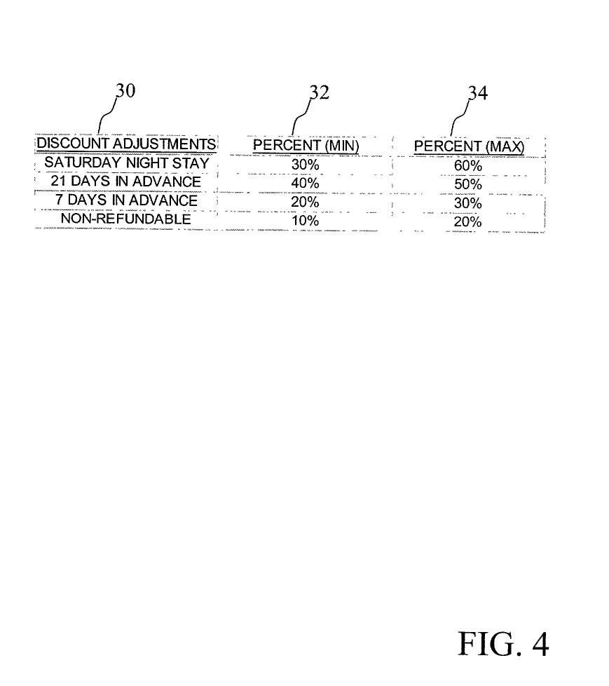

FIG. 4 shows a representative database for airline ticket discount information. As shown in FIG. 4, the representative database may contain a field with the discount description 30, a field for the minimum percentage price discount for a given discount description 32, and a maximum percent discount for a given discount description 34. Representative discounts may include a discount for round-trip tickets that have a weekend night in between, because the hotels may compensate the airlines for encouraging their passengers to spend a weekend night at the hotel.

Representative discounts may also include, for example, advanced ordering tickets, such as those ordered 21 days in advance, or 7 days in advance. Furthermore, discounts may be given for ordering non-refundable tickets. The percentage of savings varies depending on the type of discount. The discounts for more than one discount acquiring behavior may in some instances be combined for greater savings. In an additional embodiment of the present invention, after the user enters requested flight information, various airline companies are contacted to determine whether one or more airline companies are offering special discounts that are applicable to the requested flight. Discounts often range between airlines in terms of a discount percentage value of the normal flight price. The range is reflected in the minimum and maximum discount percentage rate for each type of discount.

In an alternative embodiment, the processor selects flight travel products by searching through the global distribution server, and possibly through travel product databases stored by individual travel product suppliers, to find alternative flight travel products. In an embodiment, the processor alters the desired flight travel product characteristics and searches based on the new characteristics. Alternatively, the processor searches the travel product databases for flight travel products having characteristics within a predetermined variation from the requested flight travel products. Preferably, the global distribution server and the individual travel product provider databases contain information regarding the discounts that each flight travel product is taking advantage of. Thus, the processor can determine the applicable discounts and communicate them to a user.

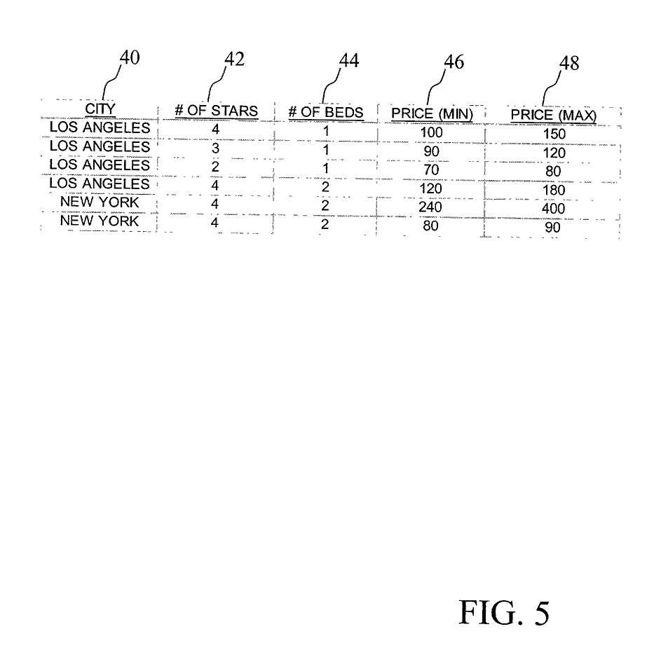

FIG. 5 shows an exemplary database of hotel information. The hotel information kept may include the city in which the hotel is located 40, and the ranking of the hotel in terms of the number of stars that it has received in guide books 42. Additional information about hotels may include the number of beds in the hotel room 44. As part of the hotel room information, the minimum price 46 for hotel rooms of hotels of a specified number of stars with a specified number of beds in a specified city. The database also contains a maximum price for a hotel of a given number of stars containing a specified number of beds in a specific city 48. In an embodiment of the present invention, the minimum and maximum prices are obtained by analyzing several different hotels with the specified number of stars and beds. In an additional embodiment, the hotel information database may contain additional information, such as whether the rooms in the hotel have cable television and whether the hotel has air conditioning which may be communicated to a user to help them choose a hotel.

Additionally, the hotel information database may contain fields for specific dates and days. In an embodiment, the minimum and maximum prices reflect a range that has been obtained by viewing the different prices for particular hotel rooms in a city for various day and time periods to determine fluctuations in price.

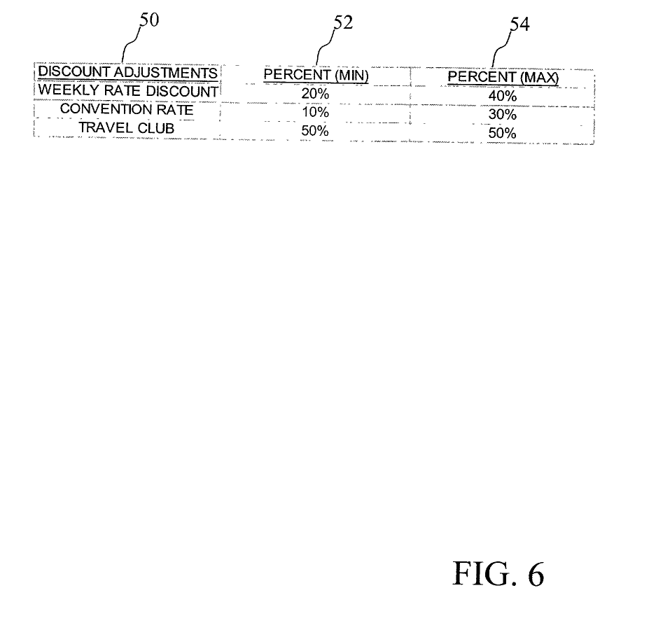

FIG. 6 shows a database with discount information for hotel rooms. A hotel room discount database according to an embodiment of the present invention may include a discount description field 50, the minimum percentage discount that a particular discount will afford 52, and the maximum percentage discount that a given discount description will afford. For example, if a hotel room is rented for one week, often a weekly rate discount applies. Additionally, hotels often provide discounts for convention patrons, and for travel club members. The rate discounts often range in terms of a discount percentage value of the normal hotel room price from hotel to hotel. This is why there is a range of minimum to maximum discounts listed for each type of discount. In an additional embodiment of the present invention, after the user enters requested hotel information, or after necessary hotel information is gleaned from the flight destination and the time between the departure flight and the return flight, various hotel companies are contacted to determine whether one or more hotel companies are offering special discounts that are applicable to the requested hotel.

In an alternative embodiment, the processor selects hotel travel products by searching through the global distribution server, and possibly through travel product databases stored by individual travel product suppliers, to find alternative hotel travel products. In an embodiment, the processor alters the desired hotel travel product characteristics and searches based on the new characteristics. Alternatively, the processor searches the databases for hotel travel products having characteristics within a predetermined variation from the requested hotel travel products. Preferably, the global distribution server and the individual travel product provider databases contain information regarding the discounts that each hotel travel product is taking advantage of. Thus, the processor can determine the applicable discounts and communicate them to a user.

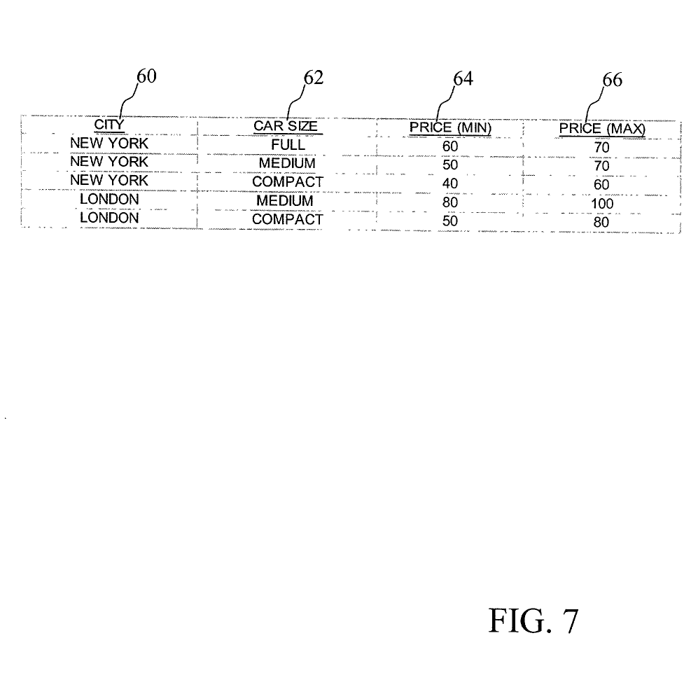

FIG. 7 shows a representative car rental statistic table. A car rental statistical table according to an embodiment of the present invention contains the city in which the car will be rented 60. The auto rental database also contains the type of car that is being rented, for example, full size, medium size, and compact size. The table also contains a minimum price for a given size car in a specified city 64, as well as a maximum price for a given size car in a specified city. For example, a full size car in the city of New York may cost between a minimum price of $60 per day and a maximum price of $70 per day.

Additionally, the car rental statistical database may contain fields for specific dates and days. In an embodiment, the minimum and maximum prices reflect a range that has been obtained by viewing the different prices for particular rental car types in a given city for different given day and time periods.

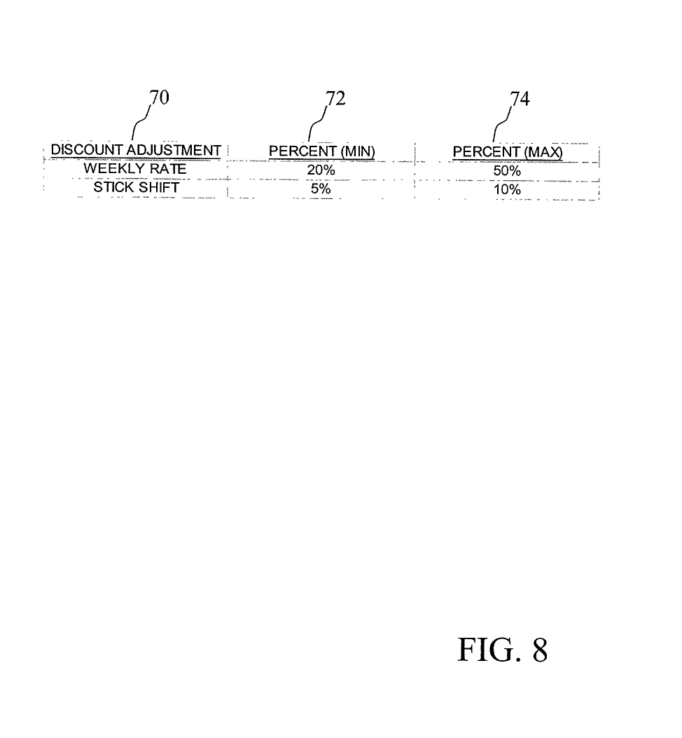

FIG. 8 shows an exemplary discount table for auto rentals. The discount table for auto rentals according to an embodiment of the present invention contains a description of the discount 70. The table also contains fields for the minimum percent price discount for a given discount description and a maximum percentage price discount for a given discount description. For example, often auto rental companies provide discounts for those rental customers who rent a car for one week or more. Often the percentage of discount from the daily rate that is afforded to a customer who rents a rental car for more than one week varies by company from a minimum percentage discount to a maximum percentage discount. In an additional embodiment of the present invention, after the user enters requested car rental information, or after necessary car rental information is gleaned from the flight destination and the time between the departure flight and the return flight, various car rental companies are contacted to determine whether one or more car rental companies are offering special discounts that are applicable to the requested car rental.

In an alternative embodiment, the processor selects car rental travel products by searching through the global distribution server, and possibly through travel product databases stored by individual travel product suppliers, to find alternative car rental travel products. In an embodiment, the processor alters the desired car rental travel product characteristics and searches based on the new characteristics. Alternatively, the processor searches the databases for car rental travel products having characteristics within a predetermined variation from the requested car rental travel products. Preferably, the global distribution server and the individual travel product provider databases contain information regarding the discounts that each car rental travel product is taking advantage of. Thus, the processor can determine the applicable discounts and communicate them to a user.

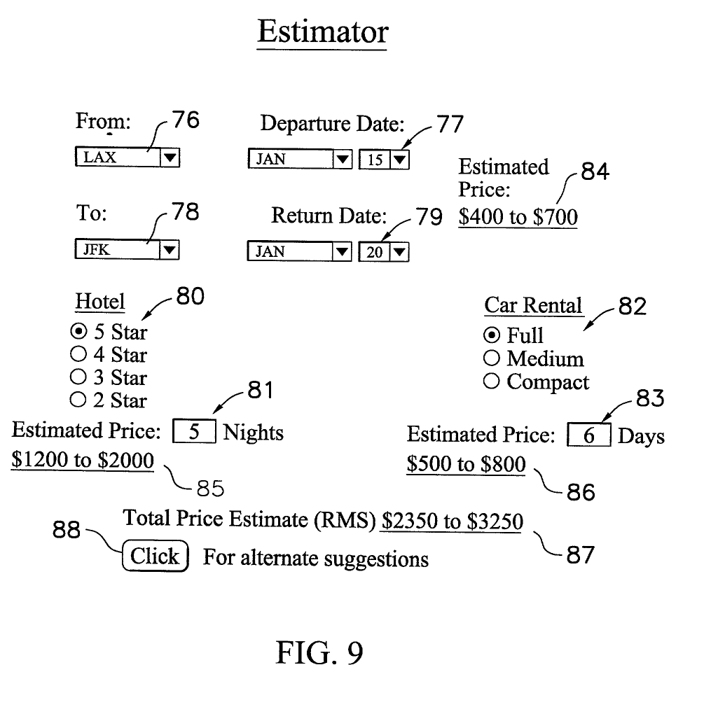

FIG. 9 shows a user interface that is presented to the user of the present system according to an embodiment of the present invention. As shown in FIG. 9, a user is prompted to enter a departure location for an airline flight 76, as well as the departure date 77. A user is also prompted to enter the arrival destination city for the airline flight 78, as well as the date that they wish to return to the departure city 79. Below the airline information, the user is prompted to enter hotel information.

A user may enter the hotel information by selecting a given star categorization of a hotel 80. As shown in FIG. 8, the hotels may be subdivided into five-star hotels, four-star hotels, three-star hotels, and two-star hotels. In an embodiment of the present invention, the city in which the hotel is located is obtained from the user's selection of an airplane destination city. In an alternative embodiment, the user is prompted to enter the city in which the hotel is located. The user is prompted to enter the number of nights that they intend to stay in the hotel room 81. Alternatively, the number of nights that a user will stay in a hotel room is gleaned from the amount of time between the departure flight and the return flight. In yet another alternative embodiment, the user is prompted to enter more than one hotel with arrival and departure dates, and city locations for each.

In addition to airlines and hotel rooms, a user is also prompted to enter car rental information. For example, the car rental information may be a choice between different sizes of cars 82, such as full, medium, or compact cars. The user is prompted to enter the number of days which they wish to rent a car 83. Alternatively the number of days for which a user wishes to rent a car may be obtained from the amount of time between the departure flight and the return flight. Alternatively, a user is prompted to enter more than one car rental along with the locations and duration of each rental.

In an embodiment of the present invention, the user interface is interactive, so that once a user selects, for example, a departure city, a return city, the departure and return dates, and seat class for their airline flight, the system displays the estimated price range of the airline flight for the user 84. Likewise, once the user has entered the destination city for the airline flight, the type of hotel they wish to occupy, the type of room that they want, and the length of stay, the system generates an estimated hotel cost 85. Once the user has entered an airline destination city and chosen the type of car that they wish to rent, as well as the duration of the car rental period, the system estimates the car rental price for the user 86.

As the system estimates the prices for the airline tickets, the hotel, and the car rental, the system also displays a total price estimate for the user 87. In an embodiment, airlines, hotel rooms, and car rentals each have a range of prices going from a minimum to a maximum, and each of the airline tickets, the hotel rooms and the auto rentals may be added up to get a range of minimum to maximum overall trip prices. Alternatively, a root-mean-square method, or other statistical method to give less weight to the extremes of the individual ranges, is used to calculate the overall range in the total price estimate.

In an alternative embodiment, only the lowest priced travel products found having the desired characteristics are displayed. Likewise, the total price given to the user is calculated by adding up the lowest price individual travel products. In yet another alternative embodiment, the actual prices and information about each travel product having the desired characteristics are displayed, rather than a range of prices.

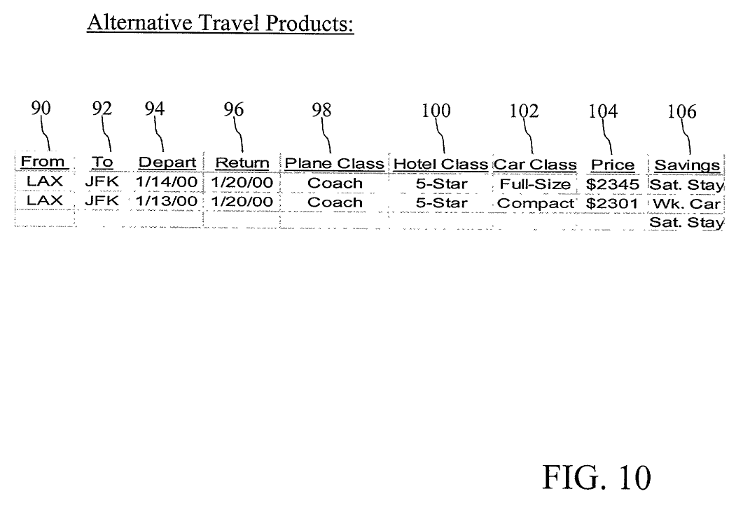

In an embodiment of the present invention, the prompting screen contains a button 88 that the user can press to submit a request for alternative travel products to take advantage of discounts based upon the information already entered. If a user selects the alternative suggestion button on the user interface, the system generates a list of one or more alternative travel products for the user. An alternative list is shown in FIG. 10. FIG. 10 shows a departure location for an airline 90, an arrival location for an airline 92, a departure date and time 94, and a return date and time 96. Additionally, the alternative suggestion generated for the user displays a hotel classification 98, and room information 100 as well as a car rental description 102. The alternative suggestion displayed to the user also contains a total estimated price 104. Finally, the alternative suggestion displayed for the user contains a category entitled “Savings” 104, in which the steps taken to lower the cost of the travel are detailed for the user. For example, the alternative suggestion may propose a lower total price if the user is willing to depart 1 day earlier to capture a Saturday night stay discount. The lower total price may be the result of a cheaper airline flight, even though the hotel and car rental prices may increase.

In an alternative embodiment of the present invention, the system automatically generates and displays a list of one or more alternative travel products for the user. The alternative list is forwarded to a user along with a list of travel products that satisfy their request parameters. The list of travel products may take the same form as the list shown in FIG. 10 and previously described.

In another alternative embodiment of the present invention, the user inputs a departure city, a departure date, a destination city, and a length of stay. The various inputs may be general for example, a departure or destination state, as well as a desired month of departure. In an additional embodiment, the user also inputs how flexible they are with regard to at least one of the departure city, departure date, destination city and length of stay. The user may input limited information and the processor may explore many alternatives. For example, a user can enter the departure city, destination city, and the price they wish to spend. Once the trip information is entered by a user, the processor runs numerous permutations to determine different prices for different options. The processor generates a user interface presenting the different options to the user along with dates, flight, hotel and car rental information for each option.

If, for example, the user enters that they wish to travel from Los Angeles to new York for 5 days in February and would like to stay within in a budget of $1,000, then the user enters the information and leaves any other input boxes empty. The processor then searches the databases, and using an optimization scheme, such as linear programming, determines all of the options that fit the user's parameters. If there are many permutations then the permutations may be listed from lowest price to highest price. If there are no permutations that fit the request, the system proposes the closest permutation for the users education.

Once a travel product list is displayed for a user, a user is prompted to purchase any or all of the travel products offered to them. For example, a user is prompted to purchase airplane flights that fit within the requested travel product parameters. If the user elects to make a purchase, then the user is prompted for their personal information and payment information so that the processor may contact the selected travel product sellers to make the requested reservations and purchases.

In should be realized that the above travel products are only representative and that the system and method are applicable to other types of travel products. In an embodiment, the user may request cruise travel products. A user selects a cruise by entering a cruise departure date, a cruise departure location, a cruise destination location, a cruise return date, and a cruise passenger class. In an additional embodiment, the user may elect train travel products. A user selects a train trip by entering a departure date, a departure location, a destination location, a return date, and a passenger class. In another embodiment the user may elect travel activity products such as scuba diving, snorkeling, and safari tours.

The preceding description has been presented with reference to presently preferred embodiments of the invention. Workers skilled in the art and technology to which this invention pertains will appreciate that alterations and changes in the described structure may be practiced without meaningfully departing from the principle, spirit and scope of this invention. Accordingly, the foregoing description should not be read as pertaining only to the precise system and method described and illustrated in the accompanying drawings, but rather should be read consistent with and as support for the following claims, which are to have their fullest and fairest scope.

1. An electronic method for calculating travel costs for a user comprising:
an information request step, wherein the user is prompted to enter desired travel product information for a plurality of travel products;
an information receipt step, wherein the desired travel product information is received from a user;
a calculation step, wherein the received information is used to search through a database to determine the cost of the desired travel products; and
a reporting step, wherein the cost of each travel product is reported to the user.
a prompting step wherein the user is prompted to request alternative travel product information; and
an alternative travel request receipt step wherein a user request to receive alternative travel product information is received.
a second calculating step wherein a discount database is accessed to determine alternative travel products to offer the user; and
an alternative travel reporting step wherein alternative travel products are reported to the user.

2. An electronic method for calculating travel costs of claim 1 wherein the reporting step and the alternative travel reporting steps comprise displaying a range of prices for each travel product based upon availability of products from different product providers; and displaying a total price range for all of the requested travel products.

3. An electronic method for calculating travel costs of claim 2 wherein the information request step further comprises prompting a user to select an airline departure date, a departure location, a destination location.

4. An electronic method for calculating travel costs of claim 3 wherein the information request step further comprises prompting a user to select a hotel location and a number of nights to reside at the hotel.

5. An electronic method for calculating travel costs of claim 4 wherein the information request step further comprises prompting a user to select a rental car location and a number of days a rental car will be rented.

6. An electronic method for calculating travel costs of claim 5 wherein as part of the calculation step, the received duration of time between the airplane departure date and the airplane return date is used to determine the number of nights to reside at the hotel and the number of days a rental car will be rented.

7. An electronic method for calculating travel costs of claim 6 wherein as part of the calculation step, the airplane destination city is used to determine the hotel location and the rental car location.

8. An electronic method for calculating travel costs of claim 5 wherein alternative travel products are found by altering at least one of the group consisting of the departure flight city, the departure flight date, the destination city, the return flight date, the number of nights of hotel rental, the type of hotel rented, the number of days of car rental, and the type of car rented to conform to the requirements of at least one discount in the discount database.

9. An electronic method for calculating travel costs of claim 8 further comprising a prompting step wherein a user is prompted to purchase travel products.

10. An electronic method for calculating travel costs of claim 9 further comprising:
a personal information prompting step wherein the user is prompted to enter personal information;
a personal information receiving step wherein personal information is received from a user;
a payment information prompting step wherein the user is prompted to enter payment information;
a payment information receiving step wherein payment information is received from a user; and
a reservation step wherein travel product providers of the purchased products are contacted, reservations are made, and travel products purchased.

11. An electronic method for calculating travel costs of claim 10 wherein the information request step further comprises prompting a user to select at least one of the group consisting of a cruise departure date, a cruise departure location, a cruise destination location, a cruise return date, a cruise provider, a cruise ship, a cruise name, and a cruise passenger class.

12. An electronic method for calculating travel costs for a user comprising:
an information request step, wherein the user is prompted to enter desired travel product information;
an information receipt step, wherein desired travel product information is received from a user;
a first calculation step, wherein the received desired travel product information is used to search through a database of travel products to determine the cost of the desired travel products;
a second calculation step, wherein the database of travel products is searched for alterations of the received desired travel product information to take advantage of discounts; and
a reporting step, wherein the cost of each travel product is reported to the user.

13. An electronic method for calculating travel costs of claim 12 wherein the information request step further comprises:
prompting a user to enter at least one of the group consisting of desired airline, cruise, train, hotel and car rental information.

14. A system for determining travel product prices for users comprising:
an information server coupled to a computer network;
a user terminal coupled to the computer network;
a first database coupled to the computer network for storing airplane flight information; and
a second database coupled to the computer network for storing hotel information;
a third database coupled to the computer network for storing rental car information;
wherein the information server is configured to receive requests for information from the user terminal, aggregate airplane flight information from the first database, hotel information stored in the second database, and car rental information stored in the third database, and transmit the airplane flight information, hotel information, and car rental information to the user terminal.

15. A system for determining travel product prices of claim 14 further comprising:
an airplane flight discount database;
a hotel discount database; and
a car rental discount database;
wherein the information server is further configured to obtain discounted travel product information from the airplane flight discount database, the car rental discount database, and the car rental discount database; and
wherein the information server is further configured to transmit discounted travel product information to the user terminal.

16. A computer readable medium having stored thereon a set of instructions including instruction for distributing travel product information, the instruction, when executed by a microprocessor cause the microprocessor to perform the steps of:
requesting desired travel product information;
receiving desired travel product information;
searching a database of travel product information for travel product information based upon the received desired travel product information;
aggregating travel product information based upon the received desired travel product information and based upon available travel product discounts;
transmitting the aggregated travel product information to the user;
searching a database of travel products;
selecting in the database of travel product discounts alternative travel products to the received desired travel products that qualify for a discount; and
transmitting the alternative travel products to a user.

17. An electronic method for calculating travel costs for a user comprising:
an information request step, wherein the user is prompted to enter desired travel product information for a plurality of travel products;
an information receipt step, wherein the desired travel product information is received from a user;
a calculation step, wherein the received information is used to search through a database to determine the cost of the desired travel products; and
a reporting step, wherein the cost of each travel product is reported to the user;
a second calculating step wherein a discount database is accessed to determine alternative travel products to offer the user; and
an alternative travel reporting step wherein alternative travel products are reported to the user.

18. An electronic method for calculating travel costs of claim 17 wherein the information request step further comprises prompting a user to select attributes for at least one of the group consisting of cruise, airplane, hotel and car rental related travel products.

19. An electronic method for calculating travel costs of claim 18 wherein the reporting step comprises displaying a range of prices for each travel product based upon availability of products from different product providers; and displaying a total price range for all of the requested travel products.

20. An electronic method for calculating travel costs of claim 18 wherein the alternative travel reporting step comprises displaying alternative travel products in sets, and displaying a total price range for all of the selected alternative travel products in a given set.
